(19) United States
(12) Patent Application Publication
(10) Pub. No.: US 2016/0225089 A1
(43) Pub. Date: Aug. 4, 2016

(54) ESTABLISHING AND MAINTAINING A SUSTAINABLE INCOME STREAM TO DEFRAY RECURRING SERVICE EXPENSES IN ORDER TO ENABLE LONG-LASTING DOMAIN REGISTRATIONS

(71) Applicants: Kong Posh Bhat, Plano, TX (US); Atul Vohra, Dallas, TX (US)

(72) Inventors: Kong Posh Bhat, Plano, TX (US); Atul Vohra, Dallas, TX (US)

(21) Appl. No.: 14/609,445

(22) Filed: Jan. 30, 2015

(51) Int. Cl. G06Q 40/06; G06Q 20/10

(52) U.S. Cl. CPC G06Q 40/06; G06Q 20/10

(57) ABSTRACT

The present invention relates to a system and method for enabling long-lasting Internet domain registration (e.g. 100 years). Members pay once and all recurring fees and expenses are covered through a sustainable income stream which secures the said domain name and protects against losing the domain due to incorrect credit card, failed billing or outdated account contacts, and ensures continuity for future generations.

### CROSS REFERENCE TO RELATED APPLICATIONS

Not applicable.

### BACKGROUND

1. Field of the Invention

The disclosure relates to a method for generating a sustainable income stream, from an initial investment, to pay for recurring expenses for a user, which in turn enables long-lasting Internet domain name registration (e.g. 100 years). In addition, the user may receive occasional bonus payments, depending upon how the overall investment is doing.

2. General

A domain name is a distinctive digital sign and address used by businesses, individuals, organizations and other legal entities to identify and distinguish themselves and their goods and services, on the Internet, from those of other entities. The Internet has been a prominent feature of our lives since the latter part of the 20th century. Examples of services, resources and functions that get delivered over the Internet include the World Wide Web, with the delivery of requested information in HTML (Hypertext Markup Language) and other similar formats that include, but is most certainly not limited to, PHP, JSP, Flash, DHTML, ASP, ASPX and more. This information is often rendered in a web browser such as Internet Explorer, Apple Safari and Mozilla Firefox, and is commonly accessed and identified by primary identifiers known as Internet domain names. These Internet domain names provide easily recognizable and memorizable names to numerically-addressed Internet resources. Examples of domain names include apple.com, whitehouse.gov, google.co.uk, and mit.edu.

Internet domain names are used as an addressing method for accessing a plethora of other services, such as accessing and transferring files via the File Transfer Protocol (FTP). Internet domain names are also, among other purposes, used to identify the senders and recipients of electronic mail (e-mail) and to manage routes for the actual transmission of these e-mail messages. It is clear that domain names play an extremely critical function in the operation of the Internet. Other uses of domain names as an addressing method include SFTP (Secure File Transfer Protocol), RTSP (Real Time Streaming Protocol), and more. In 2013 more than 1 billion buyers spent over $1.2 trillion on goods and service purchased over the Internet (Source Statista 2015). Domain names are critical mechanisms for building a unique brand identity online, and they are the drivers for communication, ecommerce and online entertainment.

Domain names have multiple components. In the example of apple.com, ‘apple’ is the second-level domain (SLD), while ‘com’ is the top-level domain (TLD), otherwise known as a suffix. Examples of TLDs are .com, .net, .org, .info, .biz, .mobi, and .name. Other TLDs include country-code variants (otherwise known as ccTLDs) such as .de, .co.uk, and .com.cn. TLDs are managed by registries (also known as registry operators). These registries maintain domain name registration information. In most cases, registry operators contract with designated (or accredited) domain name registrars to provide domain name registration services to the public (end users) with minimal limitations. Registrars may then offer registration of domain names through reseller affiliates. End-users may register any domain name through registrars, or their resellers. A domain name may generally be registered for periods ranging from 1 year up to a maximum period of 10 years.

The issue of lapsed domain names is a serious occurrence for many end-users. This happens for several reasons such as incorrect credit card, failed billing or outdated account contacts. The process to redeem domains is expensive and risky. It involves fees associated with reinstating or, worse still, redeeming domain names from ‘squatters’ who may seize the opportunity of a non-renewed name becoming available.

In summary, domain names, like family names or trademarks, have become an essential property and owners are anxious to protect the same but thus far have no investment vehicle based means to generate an income stream and systemic process to track and pay for registration renewals of domain names. The proposed invention described herein will provide invaluable peace-of-mind to domain name owners and potentially generate some income streams, from the investments of their upfront domain name payments. The domain name owners will have full visibility to the process of investing and paying for the required registration and concomitant administrative expenses.

3. Prior Art

Our invention is focused on protecting domain names through a series of calculations to determine returns that will cover all reasonable expenses for renewing and administering domain names registration. Thereafter, to arrive at an upfront fee which, when invested prudently, will defray the aforementioned domain related expenses and extend the renewal proactively before they lapse. This process will be repeated for a very long duration (e.g. 100 years), giving end-users the multi-generational protection they seek.

The systems and methods described in the prior art do not address the issue of generating a sustainable income stream, from an initial investment, to pay for recurring expenses for a user. The prior art systems address substantially different problems in the insurance, retirement and investment fields and accordingly are significantly different from this invention.

As per USPTO U.S. Pat. No. 5,864,685, entitled “Increasing Income Trust Computer Transaction System and Insured Investment Account System”, an investment account structure comprises one or more annuity contracts, with premiums paid for the annuity contracts being invested in one or more depository accounts, insured by deposit insurance. However, the invention discusses how to ensure that all the depository accounts remain in compliance with the requirements of depositor's insurance (e.g. meeting the FDIC limit of $100,000 in the US at the time the patent was issued, and since then raised to $250,000).

USPTO U.S. Pat. Nos. 6,950,805 and 7,644,022, entitled “System for Funding, Analyzing and Managing Life Insurance Policies Funded with Annuities”, discuss paying premiums for life insurance policy using income from annuities. However, the disclosures discuss use of borrowed money for purchase of annuities and the setting up of tax-advantageous entities in a way that reduces and/or eliminates income tax.

USPTO U.S. Pat. No. 7,398,241, entitled “Method and System for Portable Retirement Investment”, discusses increased benefits to an investor, over and above the predetermined guaranteed minimum retirement income amount, if market performance of the retirement vehicle exceeds a predefined benchmark. However, the invention deals with these issues in the context of minimum portable retirement income and minimum defined income level upon retirement, employing variable deferred annuities and variable immediate annuities.

USPTO U.S. Pat. No. 7,647,261, entitled “Method and Apparatus for Retirement Income Planning”, discusses planning an income stream to fund a desired standard of living during retirement, based on an individual's projected income and projected expenses. A complete picture of an individual's financial situation is obtained from a plurality of drivers that includes, inter alia, a pension driver. The drivers assist an investor in measuring his or her needs and making informed decisions, as they relate to the investor's goals. An annuity planner, that is linked to an on-line, real-time annuity auction, assists the investor in determining the size as well as the timing for purchasing lowest priced annuities to fund the post-retirement income stream.

USPTO U.S. Pat. No. 7,853,509, entitled “Lifetime Income”, discusses an income stream for an individual that commences at a specific time and is guaranteed as long as the individual is alive. Participants purchase “Lifetime Income Shares”, which may be purchased through periodic contributions, aperiodic contributions, or a lump-sum contribution. The total number of shares required to be purchased for meeting the periodic income needs of the individual depends upon the draw down amount and the life expectancy of an individual.

USPTO U.S. Pat. No. 8,224,673, entitled “System and Method for Administering Annuities”, discusses administering annuities using parameters such as initial funding amount, initial term, desired income annuity amount, and interest rate. However, the invention deals with the handling of different accumulation annuity renewal options viz. no renewal, renewal with no income to annuitant and renewal with income to annuitant.

USPTO U.S. Pat. No. 8,340,986, entitled “Methods and Systems for Providing Deferred Annuities with an Income Reset Feature”, includes an annuity reset feature that supports resetting at least one attribute of the annuity (referred to in the disclosure as variables of the annuity) at regular intervals. However, the purpose of this feature is to maximize the returns for the user in instances such as users getting locked into a lower interest rate, when the annuity is purchased. This feature is generally paid for with a fee that may be in the form of one or more reduced income payments or an explicit fee.

USPTO U.S. Pat. No. 8,447,681, entitled “System and Method for Administering a Destination Fund Having an Associated Guarantee”, entails comparison of the account value with a predetermined threshold on a regular basis, to determine whether or not a guarantee payment process needs to be initiated, by changing investments across a collection of available funds, where each fund has a predetermined ratio of equity and non-equity investments.

USPTO U.S. Pat. Nos. 8,521,633 and 8,725,614, entitled “Creating and Maintaining a Payout-Ready Portfolio within an Investment Plan to Generate a Sustainable Income Stream”, pertain to creating a steady lifetime income stream within an investment plan. They entail calibrating an interest rate tree and assigning a payout liability to each node of the interest rate tree to determine the constant maturity treasury equivalent rates for the limited number of investment options available in the investment plan.

USPTO U.S. Pat. No. 8,645,254, entitled “Investment Fund for Maximizing a Risk Adjusted Expected Return while Providing a Defined Minimum Income at Maturity”, entails maintaining a risk-free portfolio and an upside portfolio for an investment fund. Funds are allocated between the risk-free and upside portfolios so that the investment provides an investor with a minimum defined income stream upon its maturity date. Upon maturity, the investor receives a guaranteed minimum income stream from the risk-free portfolio and non-guaranteed assets from the upside portfolio. The invention does not quantify the relative values of the risk-free portfolio and upside portfolios. As new contributions are added to the fund, the contributions are allocated between the risk-free and upside portfolios to meet the objective of a minimum defined income stream upon maturity date. Typically allocation to the upside portfolio decreases and allocation to the risk-free portfolio increases as the maturity date approaches.

USPTO U.S. Pat. No. 8,645,255, entitled “System and Method for Providing Income Payments to an Investor”, entails maintaining multiple investment sleeves for an investment fund. The invention does not quantify the relative values of the investment sleeves. Transfer between the investment sleeves is triggered by predefined events, and the amount transferred is a function of the time remaining in the waiting period and the desired income amount. The transfer amount is a minimum of: a maximum percentage of a policy's accumulation value at a previous quarter and a percentage of an accumulation value at the quarterly transfer time.

USPTO U.S. Pat. No. 8,781,929, entitled “System and Method for Guaranteeing Minimum Periodic Retirement Income Payments Using an Adjustment Account”, entails an adjustment account for guaranteeing minimum periodic retirement income payments, if the actual retirement income payment amount is less than the guaranteed minimum periodic retirement income payment amount. The adjustment account keeps track of the additional payment required to provide the user with the guaranteed minimum periodic retirement income payment. It is not defined a priori, but it gets depleted and accumulated depending upon whether or not the actual income exceeds the guaranteed minimum income. In the event that the actual retirement income exceeds the aggregate of the guaranteed minimum income and the adjustment account balance, the adjustment account balance drops to zero and the remainder of the excess payment is passed on to the investor in its entirety.

### SUMMARY

Aspects of the disclosure overcome problems and limitations of an end user having to worry about losing a resource (e.g. Internet domain name) or access to a service on account of the inability to pay the associated dues and/or service fees in a timely manner. Aspects disclosed herein relate to not only being able to defray recurring service expenses for a pre-determined time duration, but also receiving occasional bonus payments, in the event that the returns from the investment are better than originally planned for. This financial protection is combined with a system to track renewals and provide complete transparency to the domain name owners.

The entity that accepts the payment from the end user, and establishes a sustainable income stream to defray recurring service expenses on behalf of the end user, is referred to, in this disclosure, as the service provider. The service provider is a logical entity. In one embodiment, the same entity that accepts the payment from the end user also establishes a sustainable income stream to defray recurring service expenses on behalf of the end user. In another embodiment, the functions of accepting the payment from the end user and establishing a sustainable income stream to defray recurring service expenses on behalf of the end user are performed by two or more distinct entities.

The terms “user” and “end user” are used in this disclosure interchangeably.

An exemplary case entails an end user making a lump sum payment to a service provider to cover domain name registrations for 100 years. The service provider will follow the method described in this disclosure to try to meet 2 mandatory goals:

1) establish a self-sustaining income stream that defrays the cost of the service for the end user
2) provide a periodic income to the service provider

In addition, the method described in this disclosure will attempt to meet the optional goal of occasionally paying the end user some bonus payments, in the event where the investment returns outperform the expected investment growth rate.

The preceding presents a simplified summary in order to provide a basic understanding of some aspects of the disclosure. It should not be construed as a comprehensive or an extensive overview of the disclosure. Details of the disclosure are set forth in the accompanying drawings, and in the detailed description section.

### BRIEF DESCRIPTION OF THE DRAWINGS

FIG. 1 is a flowchart of an illustrative method for establishing the product price point, which in turn decides the size of the main and auxiliary accounts, under a given set of assumptions.

FIG. 2 is a flowchart of an illustrative method for the recurring evaluation of the compounded principal value of the main account against the corresponding value from the operating amount schedule, in order to determine whether to withdraw any excess from the main account, or deposit any deficit from the auxiliary account into the main account. The operating amount schedule is a pre-computed listing of the values of the principal amount and the expected expenses, on a year by year basis, for the duration for which a self-sustainable income stream to defray recurring service expenses is desired. It factors in parameters such as the initial value of recurring expenses, the freeze period for which the recurring expenses are not expected to change, the step change for the recurring expenses at the end of a freeze period, and the expected average investment growth rate. Table 1 shows an exemplary operating amount schedule for the first sixteen years in the case where there are two annual expenses.

TABLE 1

| | Operating | | |
|---|---|---|---|
| Year # | Amount | Expense₁ | Expense₂ |
| 0 | $205.96 | $10.00 | $2.00 |
| 1 | $203.66 | $10.00 | $2.00 |
| 2 | $201.24 | $10.00 | $2.00 |
| 3 | $198.70 | $10.00 | $2.00 |
| 4 | $196.04 | $10.00 | $2.00 |
| 5 | $193.24 | $10.00 | $2.08 |
| 6 | $190.22 | $10.00 | $2.08 |
| 7 | $187.04 | $10.50 | $2.08 |
| 8 | $183.19 | $10.50 | $2.08 |
| 9 | $179.14 | $10.50 | $2.08 |
| 10 | $174.89 | $10.50 | $2.16 |
| 11 | $170.33 | $10.50 | $2.16 |
| 12 | $165.55 | $10.50 | $2.16 |
| 13 | $160.54 | $10.50 | $2.16 |
| 14 | $155.27 | $11.03 | $2.16 |
| 15 | $149.18 | $11.03 | $2.25 |
| . . . | . . . | . . . | . . . |

The terms “principal amount” and “operating amount” are used in this disclosure interchangeably.

### DETAILED DESCRIPTION

Consider an amount of money that is allowed to compound over a period of time, at an average rate of return r. Let us assume that expenses E₁, E₂, . . . Eₘ are deducted from this amount on a recurring basis. This disclosure does not impose any restriction on the units in which the time durations are expressed, but for convenience of description, we assume all time durations to be an integral number of years. We assume that the expenses are not fixed, but are expected to change over time. In one embodiment, the expenses increase over time. Furthermore, we assume that the change in the expenses takes place in a stepwise fashion i.e. the expenses remain frozen for a certain period of time, before they experience a step change to the next level. This behavior is expected to be repeated throughout the duration for which a self-sustainable income stream to defray recurring service expenses is desired. In one embodiment, an expense may be assumed to remain frozen for 10 years, and then experience an increase by 5%, which will remain in effect for the next 10 years, and so on. The case where the expense remains fixed, and does not change, is a special case in which the step increase rate is 0%.

Let represent the value of expense Eᵢ in year j.

Let Fᵢ represent the time duration for which expense Eᵢ is expected to remain frozen.

Let Δᵢ represent the expected step change in the value of expense Eᵢ after every Fᵢ years.

Let P₀ represent the starting principal amount.

In one embodiment, the service expense obligations for each year are set aside at the beginning of that year. Pₙ, the principal amount at the beginning of year n, is obtained from the formula:

$${P}_{n} = ( {P}_{n - 1} - ( {\sum }_{i = 1}^{m} {E}_{i , n} ) ) * ( 1 + r )$$

The value of E_{i,n} is obtained from the formula:

E_{i,n}=E_{i,0}*(1+Δᵢ)^{└n/F}^{ᵢ}^{┘}

The aim is to find P₀′, which is the smallest value of P₀ such that for the duration for which a self-sustainable income stream to defray recurring service expenses is desired, the value of Pₙ does not drop below the following value:

$${\sum }_{i = 1}^{m} {E}_{i , n}$$

In other words, P₀′ is the smallest value of P₀ for which all expense obligations are met, for the entire duration for which a self-sustainable income stream to defray recurring service expenses is desired.

The value of P₀ depends upon the set of assumptions regarding the initial expenses, expense rate change freeze period, expense step change value and the average expected investment growth rate.

There can be various ways in which the value of P₀′ can be established. In one embodiment, the value of P₀′ is determined by a computer program. In another embodiment, the value of P₀′ is determined from a spreadsheet. In yet another embodiment, the value of P₀′ is determined through manual calculations.

In one embodiment, some initial non-recurring expenses Ê are incurred and the computed value of P₀′ is incremented by the amount Ê.

Let us consider a hypothetical case where domain name registration entails two annual expenses E₁ and E₂. E₁ is the annual domain name renewal fee and E₂ is the annual charge for the administrative expense to monitor and protect against the inadvertent loss of the domain name due to non-timely payment of the domain name renewal fee. Let the initial values of E₁ and E₂ be $10 and $0.10, respectively, per annum. Let F₁ and F₂, the corresponding freeze periods, be assumed to be 10 and 8 years respectively. Let Δ₁ and Δ₂, the corresponding step increase in the value of the two expenses, be assumed to be 7% and 5% respectively. Let r, the average rate of return, be assumed to be 4%. If domain name registration is sought for a period of 100 years, the value of P₀′ is $295.41. As shown in Table 2 below, in the 101^{st} year (i.e. year 100 in the zero-based counting system), the operating amount falls below what is needed to meet the service expense obligations.

TABLE 2

| | | Obligations | | |
|---|---|---|---|---|
| | | | E₁ | E₂ |
| | | | (Registration | (Administrative |
| Year # | Pₙ | Total | Expense) | Charge) |
| 0 | $295.41 | $10.10 | $10.00 | $0.10 |
| 5 | $302.52 | $10.10 | $10.00 | $0.10 |
| 10 | $311.16 | $10.81 | $10.70 | $0.11 |
| 20 | $325.65 | $11.56 | $11.45 | $0.11 |
| 30 | $337.67 | $12.37 | $12.25 | $0.12 |
| 40 | $345.37 | $13.24 | $13.11 | $0.13 |
| 50 | $345.95 | $14.16 | $14.03 | $0.13 |
| 60 | $335.26 | $15.15 | $15.01 | $0.14 |
| 70 | $307.08 | $16.21 | $16.06 | $0.15 |
| 80 | $252.13 | $17.34 | $17.18 | $0.16 |
| 90 | $156.63 | $18.56 | $18.38 | $0.17 |
| 95 | $86.04 | $18.56 | $18.38 | $0.17 |
| 99 | $18.68 | $18.56 | $18.38 | $0.18 |
| 100 | $0.12 (inadequate) | $19.85 | $19.67 | $0.18 |

The value of P₀′ depends upon the duration for which a self-sustainable income stream to defray recurring service expenses is desired. If the self-sustainable income stream to defray recurring service expenses is desired “in perpetuity”, under the illustrative assumptions stated above, the value of P₀′ increases to $307.38.

The service provider will make an offer to the end user to defray recurring service expenses at a price point P_{EU} that is higher than P₀′. Once the service provider collects the payment from the end user, the service provider will establish a main account and one or more auxiliary accounts. For simplicity of description, this disclosure will assume that only one auxiliary account is set up. However, this should not be construed as a limitation of this disclosure.

The purpose of the main account is to defray the service expenses. The auxiliary account serves two purposes. First, this is the account from which the service provider draws interest income on a regular basis. Secondly, this is the account from which any deficit in the main account, needed for the main account's lifetime self-sustenance, is drawn, on an as needed basis. Generally the money in the main account will be invested in conservative financial securities, while the money in the auxiliary account will be invested in more aggressive financial securities. However, the investment strategy for both the main and the auxiliary accounts is outside the scope of this disclosure.

In the illustrative example discussed above, the service provider could set the value of P_{EU}, the end-user price, at $650. Since $295.41 is adequate for having a self-sustainable income stream to defray recurring service expenses E₁ and E₂ for 100 years, under the stated assumptions, the initial value of the main account would be set at $295.41, and the initial value of the auxiliary account would be set at $354.59.

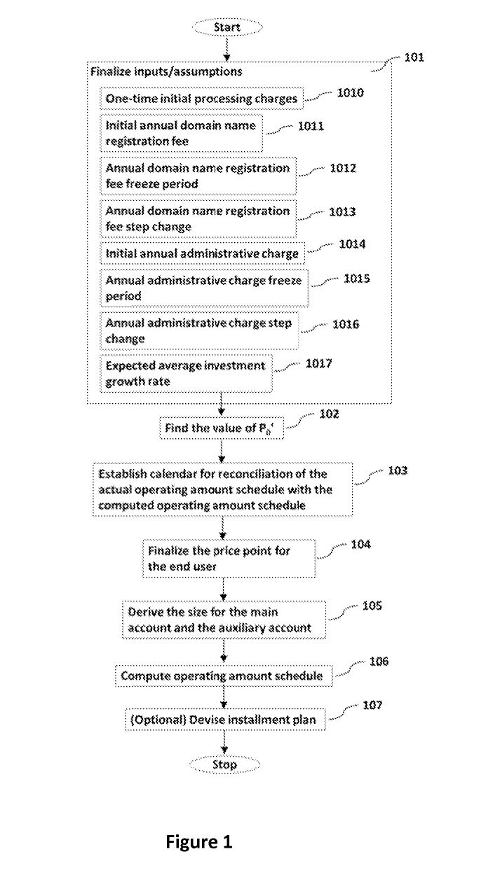

FIG. 1 illustrates a flowchart of an exemplary method that may be implemented in accordance with various embodiments for realizing a self-sustainable income stream for defraying recurring service expenses. Block 101 deals with finalizing the assumptions regarding the following:
initial one-time expenses
the initial value of recurring expenses
the freeze period for which the recurring expenses are not expected to change
the step change for the recurring expenses
expected average investment growth rate

In one embodiment, the one-time initial processing charges are set in step 1010.

In one embodiment, the initial annual domain name registration fee is set in step 1011.

In one embodiment, the annual domain name registration fee freeze period is set in step 1012. The registration fee is expected to remain frozen for this duration.

In one embodiment, the annual domain name registration fee step change is set in step 1013. It is expected that after the lapse of each domain name registration rate freeze period, the annual domain name registration fee will change by this amount.

In one embodiment, the initial annual administrative charge for each account is set in step 1014.

In one embodiment, the annual administrative charge freeze period is set in step 1015. The annual administrative charge is expected to remain frozen for this duration.

In one embodiment, the annual administrative charge step change is set in step 1016. It is expected that after the lapse of each administrative charge freeze period, the annual administrative charge will change by this amount.

In one embodiment, the expected average investment growth rate is set in step 1017.

In this illustrative example, we are only showing two recurring expenses i.e. annual domain name registration fee and annual administrative charge. However, this disclosure does not restrict the number of recurring expenses. Furthermore, the sequence of steps within Block 101 is immaterial.

The finding of the value of P₀′ is done in block 102. As mentioned elsewhere, the value of P₀′ is a function of factors such as initial one-time expenses, the initial value of recurring expenses, the freeze period for which the recurring expenses are not expected to change, the step change for the recurring expenses at the end of each freeze period, and expected average investment growth rate. This value can be determined, inter alia, by a computer program, a spreadsheet or through manual calculations.

The calendar for reconciliation of the actual operating amount schedule with the computed operating amount schedule is finalized in block 103. In one embodiment, the calendar for reconciliation is set to a periodic interval of 5 years. In such a case, every five years the service provider will compare the operating amount schedule in the main account with the computed operating amount schedule.

The service provider finalizes P_{EU}, the price point for the end user, in block 104. This is a value that lies suitably above P₀′.

The service provider derives the size for the main account and the auxiliary account in block 105. The size of the main account is P₀′ and the size of the auxiliary account is P_{EU}-P₀′.

The service provider computes the operating amount schedule, for the duration for which a self-sustainable income stream to defray recurring service expenses is desired, in block 106. This includes a listing of the values of Pₙ, on a year by year basis, for the duration for which a self-sustainable income stream to defray recurring service expenses is desired. In one embodiment, the service provider develops a library of such operating amount schedules. Each schedule has its own set of parameters like initial one-time expenses, initial value of recurring expenses, freeze period for which the recurring expenses are not expected to change, step change for the recurring expenses, expected average investment growth rate etc.

Optionally the service provider devises an installment plan, for collecting the proceeds from the end user, in block 107. The number of installments is expected to be much smaller than the number of payments that would normally be required for the duration for which a self-sustainable income stream to defray recurring service expenses is desired (e.g. 4 installments to cover domain name registration for 100 years). The service provider needs to ensure that the installment plan meets or exceeds the expected average investment growth rate that is set in step 1017. In other words, the installment payment schedule should be designed in such a way that by the time all installments have been paid, the service provider would have at least collected the compounded principal amount that would be due at that point in time, based on the expected average investment growth rate.

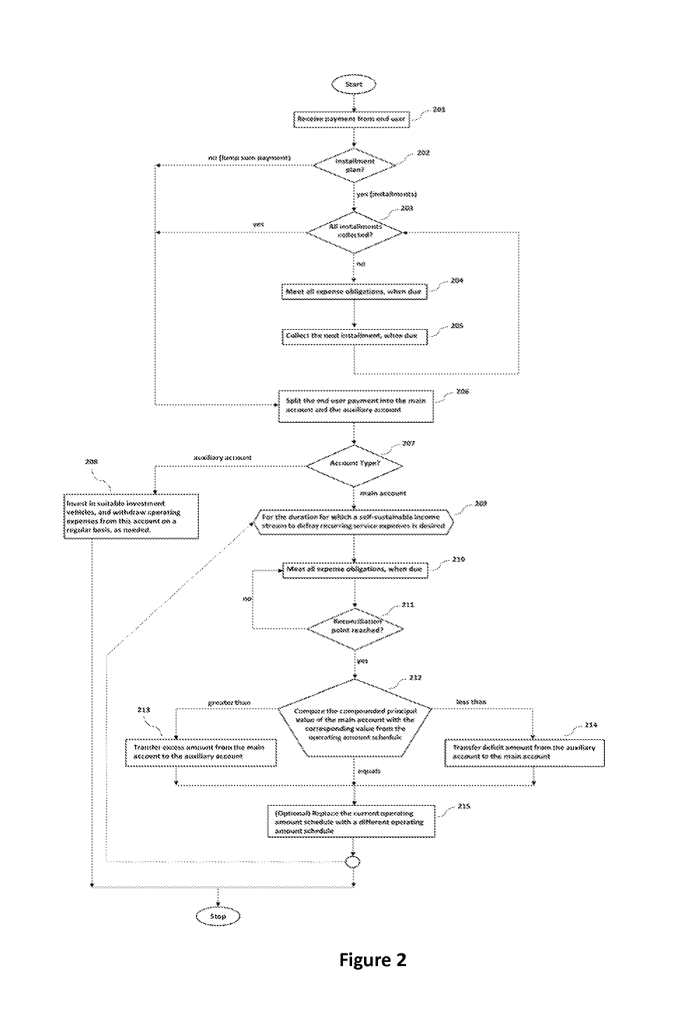

FIG. 2 illustrates a flowchart of an exemplary method that may be implemented in accordance with various embodiments, for occasional adjustments to the main account, in order to maximize the probability of the main account generating self-sustainable income throughout the duration for which defraying of the recurring service expenses is desired.

In block 201, the service provider receives payment from the end user.

In block 202, a check is made for whether it is an installment plan or a lump sum plan. In the case of a lump sum plan, the process advances to block 206. In the case of an installment plan, the process advances to block 203.

In block 203, a check is made for whether all installments have been collected. In the case where all the installments have been collected, the process advances to block 206. In the case where all the installments have not been collected, the process advances to block 204.

In block 204, the service provider meets all the expense obligations, when they are due.

In block 205, the service provider collects the next installment from the end user, when it is due. The process then returns to block 203.

By the time the process has advanced to block 206, the service provider has collected all the payment due from the end user (i.e. P_{EU}). In block 206, the service provider splits the end user payment into the main account and the auxiliary account. The size of the main account is P₀′ and the size of the auxiliary account is P_{EU}-P₀′.

In block 207, a check is made for whether the account is the main account or the auxiliary account. If the account type is auxiliary account, the process advances to block 208. If the account type is main account, the process advances to block 209.

In block 208, the service provider invests the money in the auxiliary account in suitable investment vehicles. In one embodiment, the auxiliary account is expected to grow at a rate that exceeds the estimated investment growth rate of the main account. The service provider also withdraws operating expenses from this account on a regular basis, as needed. One branch of the algorithm terminates in this block.

Block 209 is a looping construct that runs for the duration for which a self-sustainable income stream to defray recurring service expenses is desired. Within this looping construct, the process advances to block 210.

In block 210, the service provider meets all the expense obligations from the main account, when they are due. In one embodiment, the service provider renews the Internet domain name registration with the pertinent domain name registry for 10 years.

In block 211, a check is made for whether or not the reconciliation point has been reached. If the reconciliation point has been reached, the process advances to block 212. If the reconciliation point has not been reached, the process returns to block 210.

In block 212, the compounded principal value of the main account is compared with the corresponding value from the operating amount schedule. If the compounded principal value of the main account is greater than the corresponding value from the operating amount schedule, the process advances to block 213. If the compounded principal value of the main account equals the corresponding value from the operating amount schedule, the process advances to block 215. If the compounded principal value of the main account is less than the corresponding value from the operating amount schedule, the process advances to block 214.

In block 213, the excess amount is transferred from the main account to the auxiliary account. This will increase the balance of the auxiliary account, while retaining the main account at the minimum level that is required to meet all the expense obligations for the duration for which a self-sustainable income stream to defray recurring service expenses is desired.

In block 214, the deficit amount is transferred from the auxiliary account to the main account. This will increase the probability that the main account will remain self sustaining for the duration for which the defraying of recurring service expenses is desired.

Optionally the service provider replaces the current operating amount schedule with a different operating amount schedule from its library of operating amount schedules, in block 215. This terminates the looping construct (block 209).

In one embodiment, the service provider creates a disbursal schedule, which is a precomputed listing of the compounded principal amount in the auxiliary account, on a year by year basis. It factors in the annual withdrawal for the service provider, as well as the reserve amount set aside by the service provider, to handle any unexpected shortfall in the main account that could jeopardize the ability of the main account to meet service expense obligations, for the duration for which the defraying of recurring service expenses is desired. At the reconciliation point, there is a very high probability that money is either transferred to the auxiliary account from the main account, or from the auxiliary account to the main account, as shown in block 212, in FIG. 2. At this juncture, if the value of the auxiliary account exceeds the value of the precomputed disbursal schedule, the excess amount is passed to the end user as a bonus payment. The service provider may maintain a library of disbursal schedules, based on different values for the expected auxiliary account investment growth rate and the reserve amount. At the reconciliation point, the service provider may choose to replace the current disbursal schedule with a different disbursal schedule.

The foregoing description of the embodiments of the invention is not intended to be exhaustive or to limit the invention to the precise forms disclosed. It will be readily understood by those persons skilled in the art that many embodiments and adaptations of the present invention also apply to any application involving recurring expenses, where there is a danger of losing a resource or a service due to non-payment of applicable dues in a timely manner. Examples of such applications include single payment for long term coverage of supplementary health services, single payment long term warranties on auto and home repairs etc. In addition to protection against lapsed ownership or coverage, such upfront payment programs can also lock-in favorable rates. Thus our invention has multiple benefits of loss and rate protection that are enabled by the feature of one upfront payment defraying long term expenses.

What is claimed is:

1. ** A method entailing:
finding the smallest value of the starting principal amount such that it maintains a sustainable income stream to defray Internet domain name registration fees and other recurring service expenses for the duration for which defraying of such recurring service expenses is desired.

2. The method of claim 1, wherein the following assumptions are finalized:
initial one-time expenses
the initial value of recurring expenses
the freeze period for which the recurring expenses are not expected to change
the step change for the recurring expenses, at the end of each freeze period
expected average investment growth rate

3. The method of claim 1, wherein the calendar for reconciliation of the actual operating amount schedule with the computed operating amount schedule is finalized.

4. The method of claim 1, wherein the current operating amount schedule may be replaced with a different operating amount schedule, from the library of operating amount schedules, when the reconciliation point is reached.

5. ** The method of claim 1, wherein the price point for the end user is established.

6. ** The method of claim 5, wherein the initial size for the main account and the auxiliary account is established.

7. The method of claim 5, wherein the operating amount schedule is computed for the duration for which a self-sustainable income stream to defray recurring service expenses is desired.

8. ** The method of claim 5, wherein the installment plan, for collecting the proceeds from the end user, is devised.

9. The method of claim 6, wherein a library of operating amount schedules is set up.

10. The method of claim 8, wherein all expense obligations are met, when they are due, prior to all the installments being collected.

11. The method of claim 6, wherein the initial size of the main account and the auxiliary account is based upon:
smallest value of the starting operating amount for which all expense obligations are expected to be met, for the entire duration for which a self-sustainable income stream to defray recurring service expenses is desired
assumptions listed in claim 2

12. ** The method of claim 6, wherein the end user payment is split into the main account and the auxiliary account.

13. The method of claim 12, wherein the auxiliary account is invested in suitable investment vehicles.

14. The method of claim 12, wherein for the duration for which a self-sustainable income stream to defray recurring service expenses is desired, all the expense obligations are met from the main account, when they are due.

15. ** The method of claim 12, wherein the compounded principal value of the main account is compared with the corresponding value from the operating amount schedule, whenever the reconciliation point is reached.

16. The method of claim 15, wherein if the compounded principal value of the main account is greater than the corresponding value from the operating amount schedule, the excess amount is transferred from the main account to the auxiliary account.

17. The method of claim 15, wherein if the compounded principal value of the main account is less than the corresponding value from the operating amount schedule, the deficit amount is transferred from the auxiliary account to the main account.

18. The method of claim 12, wherein the service provider may occasionally choose to give the end user a cash or cash-equivalent bonus from the auxiliary account in the event where the service provider estimates that the auxiliary account has more than enough funds to make up for a deficit in the main account that would prevent the main account from remaining self sustaining for the duration for which the defraying of recurring service expenses is desired.
